(19) United States
(12) Patent Application Publication
(10) Pub. No.: US 2009/0207584 A1
(43) Pub. Date: Aug. 20, 2009

(54) Backlight module of flat panel display

(75) Inventors: Tzeng-Ke Shiau, Hsinchu (TW); Ching-Shiang Li, Hsinchu (TW); Wen-Bin Chou, Hsinchu (TW); Chih-Jen Tsang, Hsinchu (TW)

Correspondence Address: BACON & THOMAS, PLLC, 625 SLATERS LANE, FOURTH FLOOR, ALEXANDRIA, VA, 22314-1176, US

(73) Assignee: Coretronic Corporation, Hsinchu (TW)

(21) Appl. No.: 12/289,932

(22) Filed: Nov. 7, 2008

(30) Foreign Application Priority Data
Feb. 19, 2008 (TW) 097105746

(51) Int. Cl. H01J 5/16; F21V 9/00

(52) U.S. Cl. 362/97.1; 445/58

(57) ABSTRACT

A backlight module disposed under a display panel and close to a polarizer on a lower surface of the display panel is provided. The backlight module has an illumination module and an optical film disposed above the illumination module. The optical film has a lower layer and an upper layer attached to the lower layer. The upper layer is close to the polarizer and has a plurality of first micro-protrusion structures formed on an upper surface thereof. The lower layer has a plurality of second micro-protrusion structures with various heights formed on an upper surface thereof. The higher second micro-protrusion structures support the upper layer, so as to form a gap with various dimensions between the upper layer and the lower layer.

### BACKGROUND OF THE INVENTION

(1) Field of the Invention

The present invention relates to a backlight module in a flat panel display(FPD), and more particularly relates to the disposal of optical films in the backlight module.

(2) Description of the Prior Art

The crystal display technology is a passive display technology. It must have a backlight source to provide light for the panel to display image. Generally, to enhance the brightness and uniformity of the image, the light from the backlight source is capable of having both enough luminance and uniformity.

FIG. 1 is a schematic view of an optical film 100 in a typical backlight module. In FIG. 1, the optical film 100 on the light guide plate 120 has a lower diffusion film 140, a brightness enhance film(BEF) 160 and an upper diffusion film 180 in sequence. The lower diffusion film 140 has light convergence structures 142 distributed on an upper surface thereof to conduct the light from the light guide plate 120 to the normal direction of the optical film 100 to enhance the brightness. There is a prism structure 162 on the surface of the BEF 160 to raise the luminance in the normal direction. The upper diffusion film 180 has light uniform structures 182 distributed on an upper surface thereof to enhance the uniformity of the illumination. Moreover, because the liquid crystal display panel is just above the optical film 100(not shown), the upper diffusion film 180 may avoid the sharp prism structure 162 on the surface of the BEF 160 to scratch the polarizer located on the bottom of the liquid crystal display panel.

However, the optical film 100 needs the lower diffusion film 140, the BEF 160 and the upper diffusion film 180 altogether to provide uniform backlight, which causes the fabrication cost of the backlight module hard to decrease. Thus, how to reduce the number of optical films while reaching the same luminous effect is an urgent problem in this technology field.

### SUMMARY OF THE INVENTION

An embodiment of the present invention is to reduce the number of optical films used in a backlight module of a flat display to decrease the fabrication cost of the backlight module.

The backlight module in the embodiment of the present invention is disposed under a display panel and close to a polarizer on a lower surface of the display panel. The backlight module includes an illumination module and an optical film which disposed above the illumination module. The optical film has a lower layer and an upper layer attached to the lower layer. The upper layer is close to the polarizer and has a plurality of first micro-protrusion structures formed on an upper surface. The lower layer has a plurality of second micro-protrusion structures with different heights formed on an upper surface. The higher second micro-protrusion structures support the upper layer, so as to form a gap with various dimensions between the upper layer and the lower layer.

A fabrication method of the backlight module in the embodiment of the present invention provides an illumination module, an upper layer and a lower layer. The upper layer has a plurality of first micro-protrusion structures formed on an upper surface thereof, and has a smooth lower surface. The lower layer has a plurality of second micro-protrusion structures with various heights formed on the upper surface thereof. The lower layer is attached to the upper layer to form an optical film, and to form a gap with various dimensions between the upper layer and the lower layer. The optical film is disposed above the illumination module.

The conventional optical film needs the lower diffusion film, the BEF and the upper diffusion film altogether to provide uniform backlight, which causes the fabrication cost of the backlight module hard to decrease. Compared to the conventional optical film, it has now been found that the backlight module in the embodiment of the present invention needs only one optical film to provide uniform backlight with enough luminance. In this regard, it may reduce the fabrication cost of the backlight module effectively.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The present invention will now be specified with reference to its preferred embodiment illustrated in the drawings, in which

FIG. 1 is the schematic view of the optical film in a typical backlight module;

FIG. 2 is a sectional view showing an embodiment of the flat panel display according to the present invention;

FIG. 3 is a sectional view showing another embodiment of the flat panel display according to the present invention;

FIGS. 4A and 4B are schematic views showing an embodiment of the optical film in FIG. 2;

FIG. 4C is an enlarged view of the upper layer in one embodiment of the optical film in FIG. 4B;

FIG. 5 is a schematic view of the upper layer in another embodiment of the optical film according to the present invention;

FIG. 6 is a schematic view of the upper layer in another embodiment of the optical film according to the present invention; and

FIGS. 7A to 7D are schematic views showing the fabrication method of an embodiment of the backlight module according to the present invention.

### DESCRIPTION OF THE PREFERRED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention may be positioned in a number of various orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component directly or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

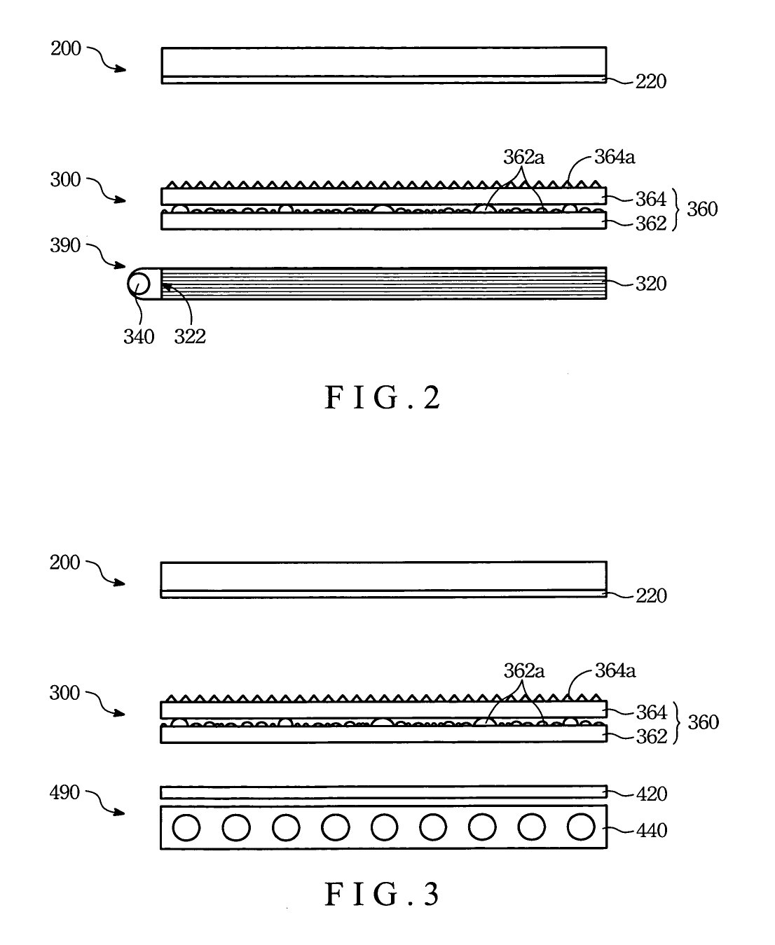

FIG. 2 is a sectional view showing a preferable embodiment of a flat panel display according to the present invention. In FIG. 2, the flat panel display has a display panel 200 and a backlight module 300 disposed under the display panel 200 and close to a polarizer 220 on a lower surface of the display panel 200. The backlight module 300 is capable of generating plane light, projected to the display panel 200 to display image.

The backlight module 300 has an illumination module 390 and an optical film 360. The optical film 360 is disposed above the illumination module 390 and close to the polarizer 220 on the lower surface of the display panel 200. In this embodiment, the illumination module 390 has a light guide plate 320 and a light source 340 adjacent to the light guide plate 320. In addition, the optical film 360 is disposed above the light guide plate 320, and the light source 340 is disposed by side of the light guide plate 320. The light from the light source 340 enters the light guide plate 320 from a light entrance surface 322 located at the side of the light guide plate 320. However, the present invention is not so limited. Referring to the embodiment in FIG. 3, the illumination module 490 has a diffusion plate 420 and a light source 440. The light source 440 is disposed under the diffusion plate 420 to provide light upwards into the diffusion plate 420.

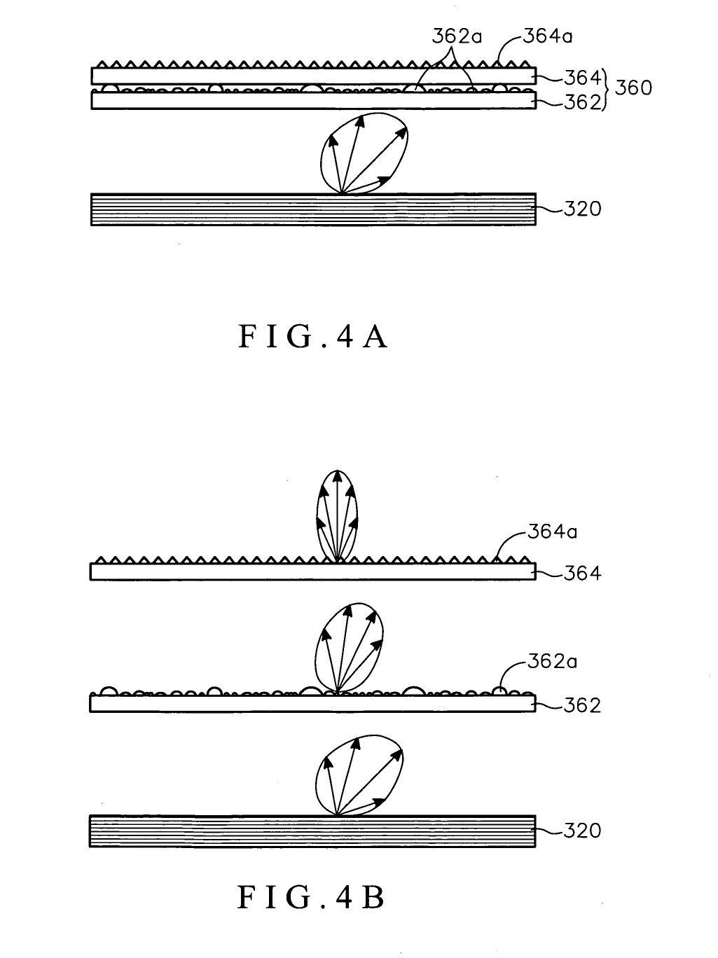

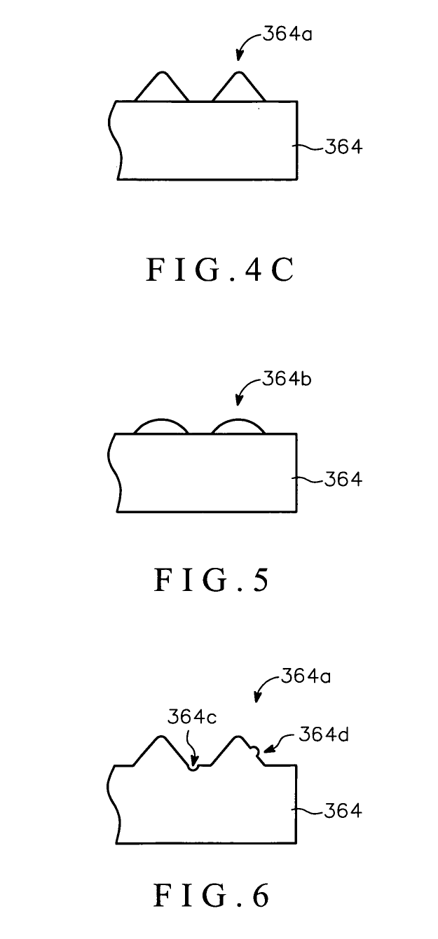

Referring to FIGS. 4A and 4B together, the optical film 360 in one embodiment of the present invention has a lower layer 362 and an upper layer 364 attached to the lower layer 362. The lower layer 362 has a plurality of second micro-protrusion structures 362a with various heights formed on an upper surface thereof to conduct the light from the light guide plate 320 of the illumination module 390 to the normal direction of the optical film 360. For instance, the lower layer 362 may be a conventional diffusion plate. The upper layer 364 has a plurality of first micro-protrusion structures 364a formed on a upper surface thereof to raise the luminance. For instance, the upper layer 364 may be an optical film having light converging function only in one direction. Furthermore, to avoid the upper layer 364 scratching the polarizer 220 above, for a preferable embodiment, the upper layer 364 may be a soft film.

Referring to FIG.4C, in this embodiment, the first micro-protrusion structure 364a on the upper surface of the upper layer 364 is a prism structure with a bending surface on the top. The first micro-protrusion structure 364a may not only raise the luminance in the normal direction, but also avoid scratching the polarizer above the optical film 360. However, the present invention is not so limited. As FIG. 5 shows, the first micro-protrusion structure 364b may also be a micro-lens structure with round surface. Also as FIG. 6 shows, the first micro-protrusion structure 364a may have a plurality of micro depressions 364c or protrusions 364d in extra to enhance the light uniformity.

Referring to FIGS. 4A and 4B, in this embodiment, the second micro-protrusion structures 362a take the form of protruding points, distributed randomly on the upper surface of the lower layer 362. In addition, the heights of the micro-protrusion structures 362a are random. The higher second micro-protrusion structures 362a support the upper layer 364, so as to form a gap with various dimensions between the upper layer 364 and the lower layer 362. The light enters the upper layer 364 from thinner medium to thicker medium, so it converges. With the first micro-protrusion structures 364a and 364b on the upper layer 364, the light may be conducted closer to normal direction to generated luminance gain. Moreover, the second micro-protrusion structures 362a in present invention are not limited to the protruding points or randomly distributed on the upper surface of the lower layer 362. These second micro-protrusion structures 362a may be arranged in an interval or an array on the upper surface of the lower layer 362, and also they may be column or other shapes.

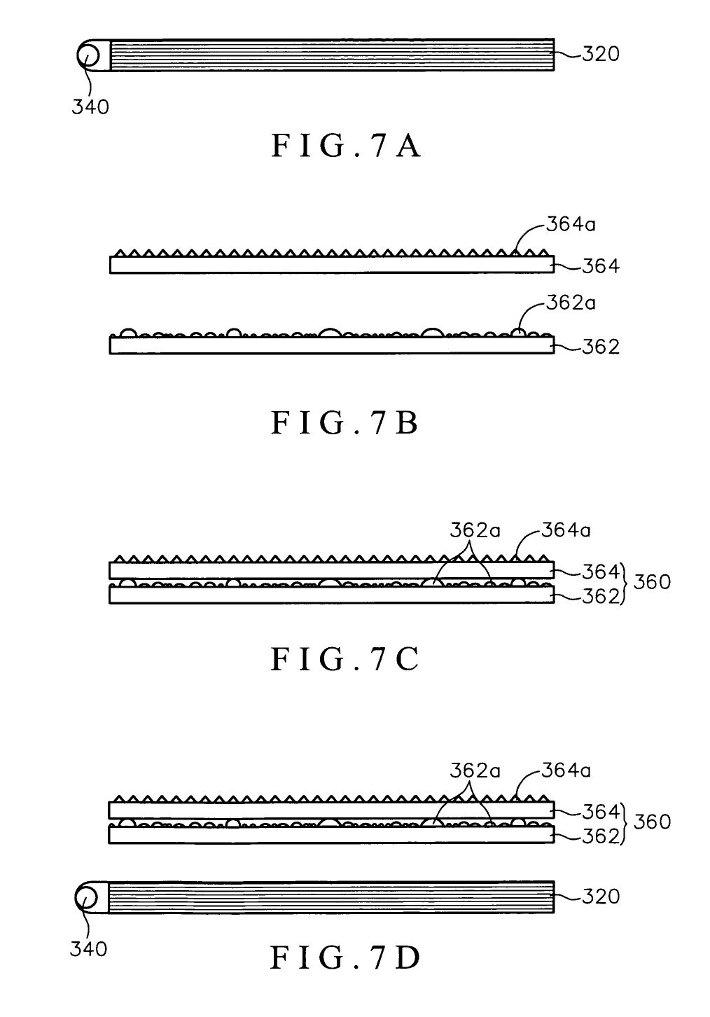

FIGS. 7A to 7D are schematic views showing the fabrication method of a preferable embodiment of the backlight module 300 according to the present invention. In FIG. 7A, an illumination module 390 is provided. In substance, the light guide plate 320 and the light source 340 closed to the light guide plate 320 are provided in the embodiment. In FIG. 7B, the upper layer 364 and the lower layer 362 are provided. The upper layer 364 has a plurality of first micro-protrusion structures 364a formed on a upper surface thereof and the lower surface of the upper layer 364 is smooth. The lower layer 362 has a plurality of second micro-protrusion structures 362a with various heights formed on a upper surface thereof. In FIG. 7C, the upper layer 364 is attached to the lower layer 362 to form the optical film 360. At the same time, a gap with various dimensions is formed between the upper layer 364 and the lower layer 362. For a preferable embodiment, the upper layer 364 may be attached to the lower layer 362 in hot melting. In FIG. 7D, the optical film 360 is disposed above the illumination module 390 to form the backlight module 300. In this embodiment, the illumination module 390 has the light guide plate 320 and the light source 340. This step is disposing the optical film 360 above the light guide plate 320 of the illumination module 390.

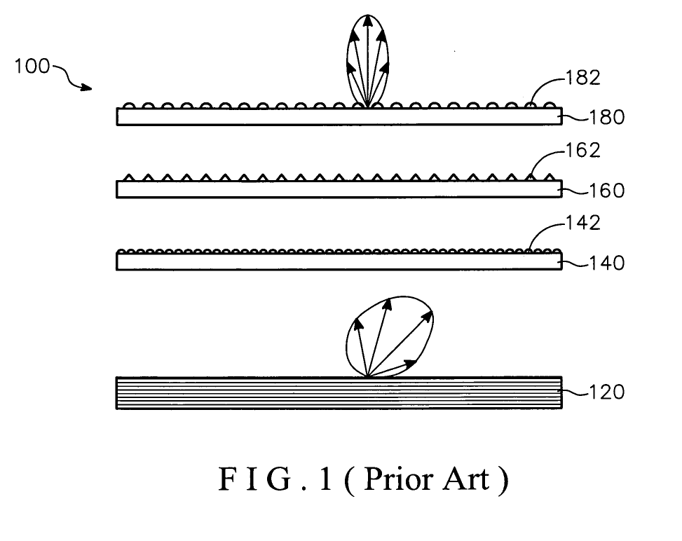

Compared to FIG. 1, the conventional optical film 100 needs the lower diffusion film 140, the BEF 160 and the upper diffusion film 180 altogether to provide uniform backlight, which causes the fabrication cost of the backlight module hard to decrease. The backlight module 300 in the embodiment of the present invention needs only one optical film 360 to provide uniform backlight with enough luminance. Moreover, the upper surface of the optical film 360 does not have sharp angle to scratch the polarizer 220 on the lower surface of the display panel 200, so the upper diffusion film 180 may be eliminated. In this regard, the backlight module 300 may reduce the number of the optical films as well as the fabrication cost effectively.

The foregoing description of the preferred embodiments of the invention has been presented for purposes of illustration and description. It is not intended to be exhaustive or to limit the invention to the precise form or to exemplary embodiments disclosed. Accordingly, the foregoing description description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A backlight module, disposed under a display panel and close to a polarizer on a lower surface of the display panel comprising:
an illumination module, providing light; and
an optical film, disposed above the illumination module, comprising a lower layer and an upper layer attached to the lower layer, wherein the upper layer is close to the polarizer and has a plurality of first micro-protrusion structures formed on an upper surface thereof, and the lower layer has a plurality of second micro-protrusion structures with various heights formed on an upper surface thereof, the higher second micro-protrusion structures supporting the upper layer, so as to form a gap with various dimensions between the upper layer and the lower layer.

2. The backlight module of claim 1, wherein the upper layer is attached to the lower layer in hot melting.

3. The backlight module of claim 1, wherein the first micro-protrusion structures comprise a prism structure with a bending surface on the top.

4. The backlight module of claim 3, wherein the first micro-protrusion structures have a plurality of micro depressions or protrusions on the surface thereof to enhance the light uniformity.

5. The backlight module of claim 1, wherein the first micro-protrusion structures comprise a micro-lens structure with round surface.

6. The backlight module of claim 5, wherein the first micro-protrusion structures have a plurality of micro depressions or protrusions on the surface thereof to enhance the light uniformity.

7. The backlight module of claim 1, wherein the second micro-protrusion structures take the form of column or protruding point.

8. The backlight module of claim 1, wherein the illumination module has a light guide plate and a light source adjacent to the light guide plate and providing light to the light guide plate.

9. The backlight module of claim 1, wherein the illumination module has a diffusion plate and a light source disposed under the diffusion plate and providing light to the diffusion plate.

10. The backlight module of claim 1, wherein the upper layer comprises an optical film having light converging function only in one direction.

11. The backlight module of claim 1, wherein the upper layer comprises a soft film.

12. The backlight module of claim 1, wherein the lower layer comprises a diffusion film.

13. A flat panel display, comprising:
a display panel;
a polarizer, under the display panel; and
a backlight module, disposed under the display panel, comprising:
an illumination module, providing light; and
an optical film, disposed above the illumination module, comprising a lower layer and an upper layer attached to the lower layer, wherein the upper layer is close to the polarizer and has a plurality of first micro-protrusion structures formed on an upper surface thereof, and the lower layer has a plurality of second micro-protrusion structures with various heights formed on an upper surface thereof, the higher second micro-protrusion structures supporting the upper layer, so as to form a gap with various dimensions between the upper layer and the lower layer.

14. A fabrication method of the backlight module, comprising:
providing an illumination module;
providing an upper layer, having a plurality of first micro-protrusion structures formed on an upper surface thereof, with a smooth lower surface;
providing a lower layer, having a plurality of second micro-protrusion structures with various heights formed on an upper surface thereof;
attaching the upper layer to the lower layer to form an optical film, wherein the higher second micro-protrusion structures support the upper layer, so as to form a gap with various dimensions between the upper layer and the lower layer; and
disposing the optical film above the illumination module.

15. The fabrication method of the backlight module of claim 14, wherein the upper layer is attached to the lower layer in hot melting.

16. The fabrication method of the backlight module of claim 14, wherein the first micro-protrusion structures comprise a prism structure with a bending surface on the top thereof.

17. The fabrication method of the backlight module of claim 14, wherein the first micro-protrusion structures have a plurality of micro depressions or protrusions on the surface thereof to enhance the light uniformity.

18. The fabrication method of the backlight module of claim 14, wherein the first micro-protrusion structures comprise a micro-lens structure with round surface.

19. The fabrication method of the backlight module of claim 14, wherein the second micro-protrusion structures take the form of column or protruding point.
